(19) United States
(12) Patent Application Publication
(10) Pub. No.: US 2019/0236653 A1
(43) Pub. Date: Aug. 1, 2019

(54) DIRECT MAIL CREATIVE REAL ESTATE POSTCARDS

(71) Applicant: Chime Technologies Inc., Salt Lake City, UT (US)

(72) Inventor: Josheph Chen, Union City, CA (US)

(73) Assignee: Chime Technologies Inc., Salt Lake City, UT (US)

(21) Appl. No.: 16/264,613

(22) Filed: Jan. 31, 2019

Related U.S. Application Data
(60) Provisional application No. 62/624,726, filed on Jan. 31, 2018.

(51) Int. Cl. G06Q 30/02

(52) U.S. Cl. CPC G06Q 30/0276; G06Q 50/16

(57) ABSTRACT

A direct mail real estate creative is presented. The creative includes a direct mail substrate on which a customized map field portion is printed on the substrate. In addition, a specific target address highlight portion is included on the substrate. Last, an advertising message highlighted on a portion of the substrate.

### CROSS-REFERENCE TO RELATED APPLICATIONS

This application claims the benefit of U.S. Provisional Application No. 62/624,726 (Attorney docket RNRNP001P), filed on Jan. 31, 2018, which is incorporated by reference herein in its entirety for all purposes.

### TECHNICAL FIELD

The present disclosure relates generally to direct mail, and more specifically to postcards.

### BACKGROUND

Direct mailing (DM) has been an important marketing tool for businesses and marketers. However, because consumers and businesses have received too many of it, the DM, either in postcard or enveloped letter form, has generally experienced low opening/viewing rates and consequently low response rate as it is hard to capture the attention of the recipient in the cluster of DMs. In addition, DMs are mostly inaccurately targeted and look exactly the same for mass production purposes. Thus, there is a need for improving target customer attention to DM by showcasing a customized map location feature on a postcard DM or enveloped letter, in order to increase the response rate for real estate DM.

### SUMMARY

The following presents a simplified summary of the disclosure in order to provide a basic understanding of certain embodiments of the present disclosure. This summary is not an extensive overview of the disclosure and it does not identify key/critical elements of the present disclosure or delineate the scope of the present disclosure. Its sole purpose is to present some concepts disclosed herein in a simplified form as a prelude to the more detailed description that is presented later.

A direct mail real estate creative is presented. The creative includes a direct mail substrate on which a customized map field portion is printed on the substrate. In addition, a specific target address highlight portion is included on the substrate. Last, an advertising message highlighted on a portion of the substrate.

Another aspect of the present disclosure includes a method for automated manufacturing of a physical direct mailing creative. The method comprises preparing a main advertising body for printing on a DM substrate. Next, the method includes automatically generating the address of the specific recipient using an automated list or an automated search engine module. Next, the method includes automatically inputting the generated address into a digital MAP address input field, thereby generating a map image corresponding to the address. Then, the method includes customizing and formatting the map image. Next, the method includes creating an advertising message, visual sign, etc., to call out the relevancy of the customized map to the actual DM message. Last, the method concludes with printing the DM creative on the DM substrate for mail distribution.

These and other embodiments are described further below with reference to the figures.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates an example of a DM creative, in accordance with one or more embodiments of the present disclosure.

FIG. 2 illustrates another example of a DM creative, in accordance with one or more embodiments of the present disclosure.

FIG. 3 illustrates another example of a DM creative, in accordance with one or more embodiments of the present disclosure.

FIG. 4 illustrates another example of a DM creative, in accordance with one or more embodiments of the present disclosure.

FIG. 5 illustrates a flow chart of a process for automated manufacturing of a physical direct mailing creative, in accordance with one or more embodiments of the present disclosure.

FIG. 6 is a block diagram illustrating an example of a computer system capable of implementing various processes described in the present disclosure.

Like reference numerals refer to corresponding parts throughout the drawings.

### DETAILED DESCRIPTION OF PARTICULAR EMBODIMENTS

Reference will now be made in detail to some specific examples of the present disclosure including the best modes contemplated by the inventors for carrying out the present disclosure. Examples of these specific embodiments are illustrated in the accompanying drawings. While the present disclosure is described in conjunction with these specific embodiments, it will be understood that it is not intended to limit the present disclosure to the described embodiments. On the contrary, it is intended to cover alternatives, modifications, and equivalents as may be included within the spirit and scope of the present disclosure as defined by the appended claims.

In the following description, numerous specific details are set forth in order to provide a thorough understanding of the present disclosure. Particular example embodiments of the present disclosure may be implemented without some or all of these specific details. In other instances, well known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. Furthermore, the techniques and mechanisms of the present disclosure will sometimes describe a connection between two entities. It should be noted that a connection between two entities does not necessarily mean a direct, unimpeded connection, as a variety of other entities may reside between the two entities. Consequently, a connection does not necessarily mean a direct, unimpeded connection unless otherwise noted.

A direct mail geo-location real estate postcard or envelope letter form and a process for manufacturing the same are presented herein. In some embodiments, creatives should be dedicated to specific addresses or homes. In some embodiments, DM postcards contain a map or property outlook creative dedicated to the specific recipient address. In some embodiments, schools, hospital or any other public facilities can be marked on the map. In some embodiments, the DM includes a transparent window, with a call to action copy.

In some embodiments, each direct mail creative includes a printed postcard specifically dedicated to a specific address as well as its estimated property value. In some embodiments, every postcard in a direct mailing is unique. In such embodiments, the specific dedication should sharply increase the response rate and ultimately convert more recipients into leads. Thus, advertising/direct mailing is practically applied to a real estate based creative using geo-location for the target address.

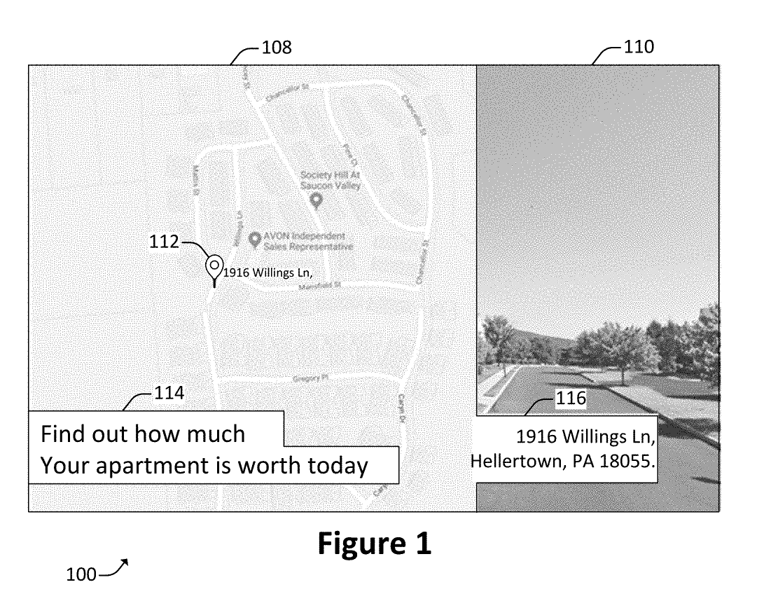

FIG. 1 illustrates an example of a DM creative, in accordance with one or more embodiments of the present disclosure. In this example, postcard 100 includes a neighborhood targeted map with a location pin 112, in the customized map field 108. In addition, the specific address 116 is highlighted in the right portion of the postcard. Last, advertising message 114 is printed in the bottom left corner of the postcard. In some embodiments, the advertising message may be highlighted in a different color or in different colors to draw extra attention to the correlative message.

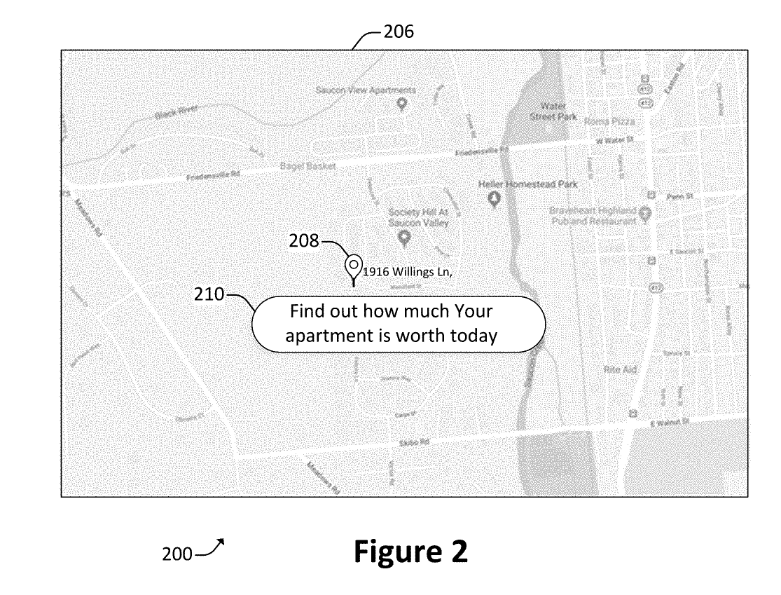

FIG. 2 illustrates another example of a DM creative, in accordance with one or more embodiments of the present disclosure. In this example, the map field 206 of the postcard 200 spans the entire postcard. The specific address for location 208 is listed but not especially highlighted in this example, thus simulating a map services screenshot. Last, advertising message 210 is printed directly under the target address pin 208 where a detailed address expansion would normally be in order to draw attention through a familiar format/new content technique.

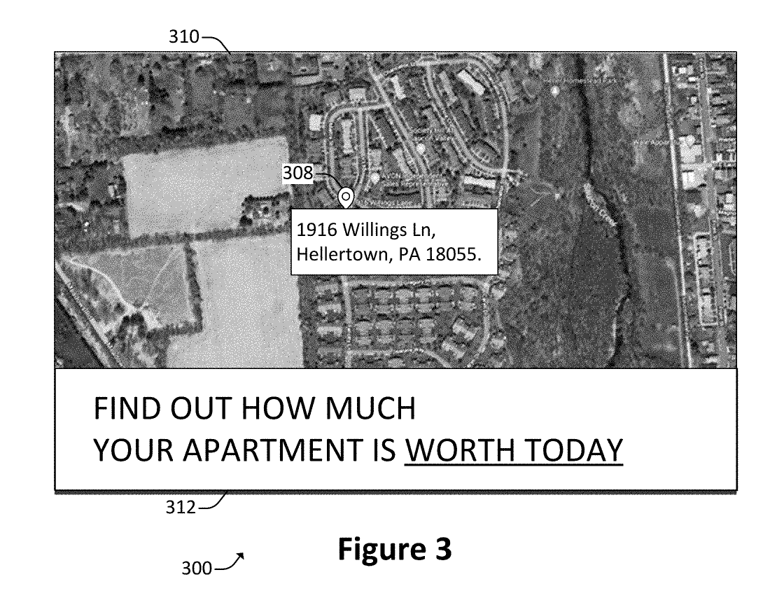

FIG. 3 illustrates another example of a DM creative, in accordance with one or more embodiments of the present disclosure. In this example, postcard 300 includes yet another neighborhood targeted map in the customized map field 310 in the top portion of the postcard. The targeted map in this example is a formatted satellite view. This is designed to appeal to recipients that prefer real life, satellite views of neighborhoods. In addition, the specific address is highlighted directly under pin 308. Last, advertising message 312 is printed in the bottom portion of the postcard. In some embodiments, advertising message 312 is highlighted in a different color or in different colors to draw extra attention to the correlative message.

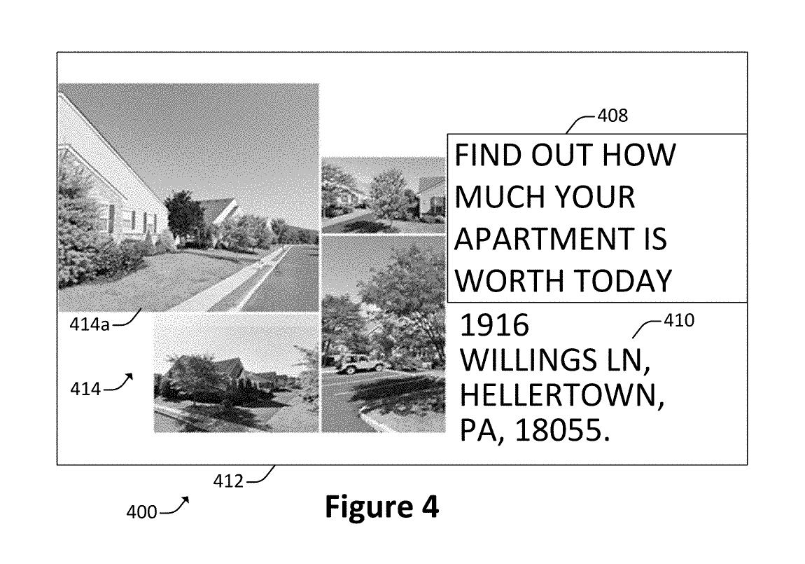

FIG. 4 illustrates another example of a DM creative, in accordance with one or more embodiments of the present disclosure. In this example, postcard 400 does not include a generated map in customized map field 412. Instead, the postcard includes a collage 414 of street views from the targeted neighborhood. The specific street view 414a showing the targeted property address highlighted by being disproportionately large in the collage in order to draw attention to that specific view. In addition, the specific address 410 is highlighted directly under advertising message 408 on the right hand side of postcard 400. Last, advertising message 408 is printed in the top right portion of the postcard. In some embodiments, the advertising message is highlighted in a different color or in different colors to draw extra attention to the correlative message in distinction to targeted address 410.

Although the creatives illustrated in FIGS. 1-4 have different placements of the addresses, maps, and advertising messages, the specific layouts of each example can be very specific in terms of the placement of the different fields in relation to each other. Each field placement arrangement is designed to attract a specific audience and to better attract an audience in general.

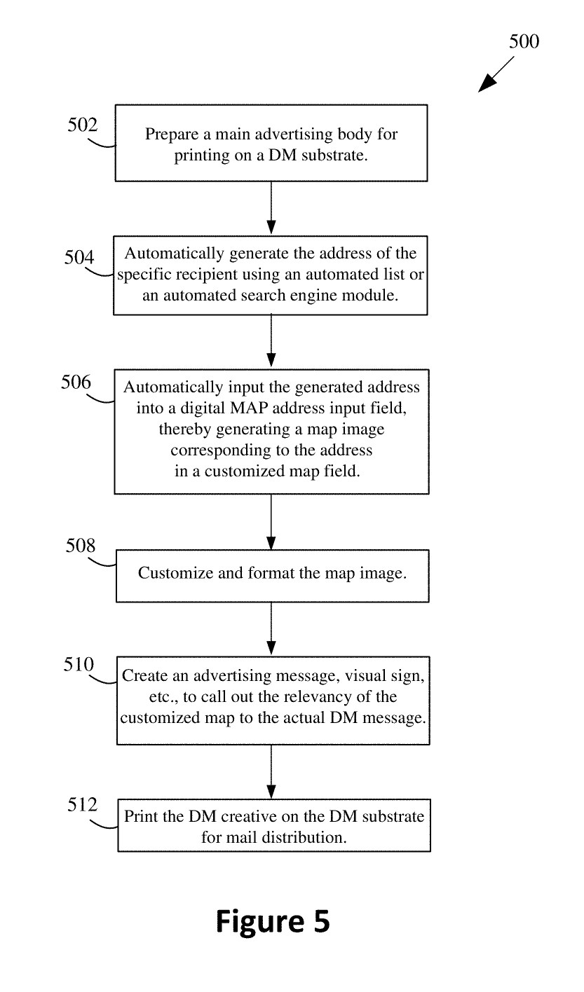

FIG. 5 illustrates a flow chart of a process 500 for automated manufacturing of a physical direct mailing creative, according to embodiments of the present disclosure. At 502, a main advertising body is prepared for printing on a DM substrate. In some embodiments, this substrate can be a postcard. In some embodiments, a space is left for a customized map field. In some embodiments, a space is left for an advertising field. In some embodiments, space is left for a highlighted address field. In some embodiments, space is left for a neighborhood collage field.

At 504, the address of the specific recipient is automatically generated using an automated list or an automated search engine module. In some embodiments, the automated list is retrieved from an open source, such as the Internet. In other embodiments, the automated list is received through a third party vendor.

At 506, the generated address is automatically input into a digital MAP address input field, thereby generating a map image corresponding to the address. In some embodiments, the digital map generator can use a customized 3D map, or a search engine map service.

At 508, the map image is customized and formatted. For example, the map image can be altered into a desired display mode, e.g., satellite view/street view, etc. In some embodiments, the customized map image is further enhanced/adjusted such that it is clearly viewable after being pasted into the customized map field space as described in 502. In some embodiments, the map image is customized and formatted to fit the entire map field and is zoomed in just large enough to show a few block radius (e.g., 2-5 block radius). In some embodiments, a location pin or marker and/or address is included in map image.

At 510, an advertising message, visual sign, etc., is created to call out the relevancy of the customized map to the actual DM message. In some embodiments, the advertising message includes: a simple, visual location sign to signify and call out the location of the actual address on the map; a callout with an advertising message, e.g., “Find out how much your apartment is worth today;” or a personalized message, e.g., “Joe, find out how much your house is worth today.”

Last, at 512, the DM creative is printed on the DM substrate for mail distribution. In some embodiments, the customized map field includes a targeted neighborhood bound map. In some embodiments, the customized map field includes a satellite view map. In some embodiments, the customized map field includes a street view map. In some embodiments, the customized map field includes a formatted or enhanced generated map specific to regional recipient preferences. In some embodiments, the substrate is prepared for postcard or envelope form mailing. In some embodiments, the customized map field includes a collage of neighborhood street view images. In some embodiments, the collage includes a highlighted image of street view of the actual house or location of the specific target address, the highlighted image being larger in size than the rest of the images in the collage.

In some embodiments, the mailing list is received from a client device. In some embodiments, the DM creatives may include different map zoom ratios to fit targeted neighborhoods. For example, in a particular neighborhood map creative, the generated map image is formatted to show the dedicated neighborhood only. In some embodiments, the neighborhood boundary lines are automatically retrieved and overlaid over the generated map image for specific formatting. In some embodiments, the estimated property price could be dedicated to a specific address or to the estimated average price for the neighborhood. In some embodiments, the generated map is edited/formatted via a painting style format.

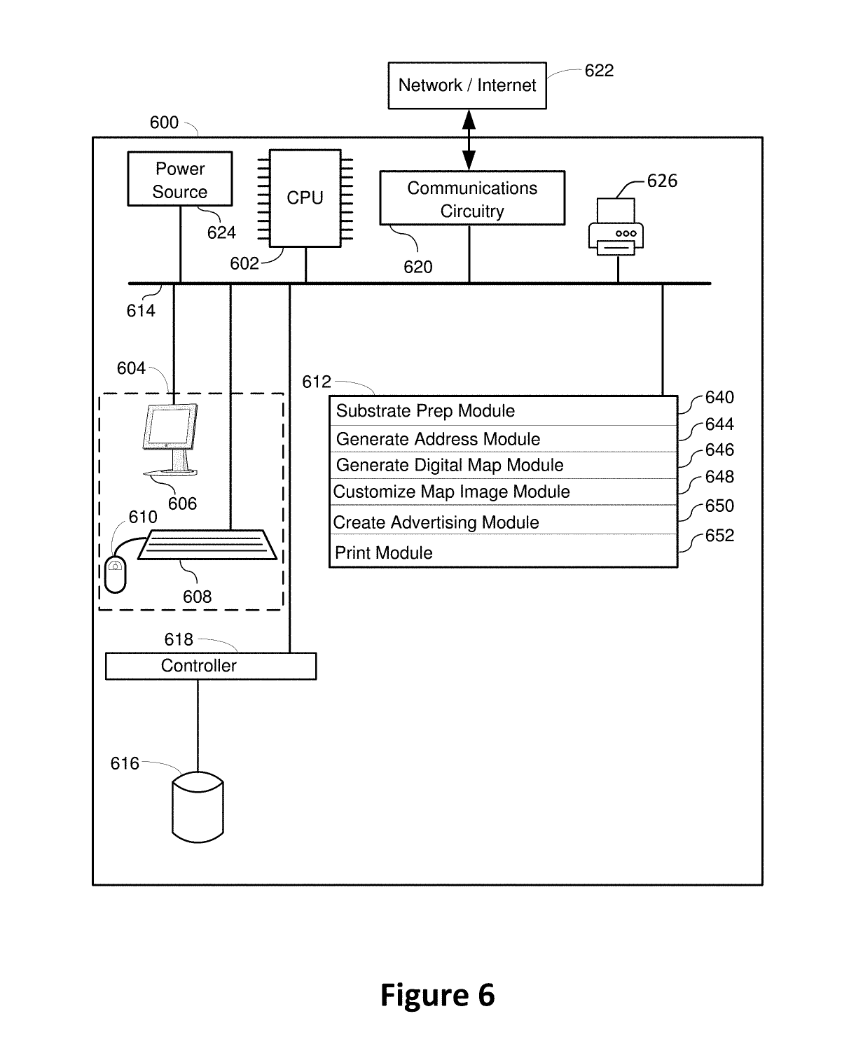

FIG. 6 is a block diagram illustrating an example of a computer system capable of implementing various processes described in the present disclosure. In some embodiments, system 600 may be system configured to implement method 500. The system 600 typically includes a power source 624; one or more processing units (CPU's) 602 for executing modules, programs and/or instructions stored in memory 612 and thereby performing processing operations; one or more network or other communications circuitry or interfaces 620 for communicating with a network 622; controller 618; and one or more communication buses 614 for interconnecting these components. In some embodiments, network 622 can be the another communication bus, the Internet, an Ethernet, an Intranet, other wide area networks, local area networks (LANs), and metropolitan area networks. Communication buses 614 optionally include circuitry (sometimes called a chipset) that interconnects and controls communications between system components. In some embodiments, system 600 also includes printer 626 for printing a DM creative onto a substrate. System 600 optionally includes a user interface 604 comprising a display device 606, a keyboard 608, and a mouse 610. Memory 612 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 612 may optionally include one or more storage devices 616 remotely located from the CPU(s) 602. Memory 612, or alternately the non-volatile memory device(s) within memory 612, comprises a non-transitory computer readable storage medium. In some embodiments, memory 612, or the computer readable storage medium of memory 612 stores the following programs, modules and data structures, or a subset thereof:
a substrate prep module 640 for preparing a DM substrate;
a generate address module 644 for automatically generating a specific address from an automated list or an automated search engine module;
a generate digital map module 646 for generating a map image corresponding to the address in a customized map field;
a customize map image module 648 for customizing and formatting the map image;
a create advertising module 650 for creating an advertising message, visual sign, etc., to call out the relevancy of the customized map to the actual DM message; and
a print module 652 for printing the DM creative on the DM substrate for mail distribution.

In some embodiments, one or more of the above identified elements may be combined and/or share applications with one or more of the above identified elements. Each of the above identified elements may be stored in one or more of the previously mentioned memory devices, and corresponds to a set of instructions for performing a function described above. One or more of the above identified modules my operate by retrieving input from one or more local storage 616 or global databases on network 622, prompting for user input at user interface 604, or providing a user with generated rules at user interface 604. The above identified modules or programs (e.g., sets of instructions) need not be implemented as separate software programs, procedures or modules, and thus various subsets of these modules may be combined or otherwise re-arranged in various embodiments. In some embodiments, memory 612 may store a subset of the modules and data structures identified above. Furthermore, memory 612 may store additional modules and data structures not described above.

Although FIG. 6 shows a system for generating a DM creative, FIG. 6 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 6 could be implemented on single servers and single items could be implemented by one or more servers. The actual number of servers used to implement a presentation generation system and how features are allocated among them will vary from one implementation to another, and may depend in part on the amount of data traffic that the system must handle during peak usage periods as well as during average usage periods.

While the present disclosure has been particularly shown and described with reference to specific embodiments thereof, it will be understood by those skilled in the art that changes in the form and details of the disclosed embodiments may be made without departing from the spirit or scope of the present disclosure. It is therefore intended that the present disclosure be interpreted to include all variations and equivalents that fall within the true spirit and scope of the present disclosure. Although many of the components and processes are described above in the singular for convenience, it will be appreciated by one of skill in the art that multiple components and repeated processes can also be used to practice the techniques of the present disclosure. In addition, the order of the method steps presented in the present disclosure are for example purposes only. It will be appreciated by one of skill in the art that the steps can be performed in a different order than the ones disclosed and still be in accordance with embodiments of the present disclosure.

What is claimed is:

1. A direct mail real estate creative comprising:
a direct mail substrate;
a customized map field portion on the substrate;
a specific target address highlight portion on the substrate; and
an advertising message a portion on the substrate.

2. The direct mail real estate creative of claim 1, wherein the customized map field includes a targeted neighborhood bound map.

3. The direct mail real estate creative of claim 1, wherein the customized map field includes a satellite view map.

4. The direct mail real estate creative of claim 1, wherein the customized map field includes a street view map.

5. The direct mail real estate creative of claim 1, wherein the customized map field includes a formatted or enhanced generated map specific to regional recipient preferences.

6. The direct mail real estate creative of claim 1, wherein the substrate is prepared for postcard or envelope form mailing.

7. The direct mail real estate creative of claim 1, wherein the customized map field includes a collage of neighborhood street view images.

8. The direct mail real estate creative of claim 7, wherein the collage includes a highlighted image of street view of the actual house or location of the specific target address, the highlighted image being larger in size than the rest of the images in the collage.

9. A method for automated manufacturing of a physical direct mailing (DM) creative, the method comprising:
preparing a main advertising body for printing on a DM substrate;
automatically generating the address of the specific recipient using an automated list or an automated search engine module;
automatically inputting the generated address into a digital MAP address input field, thereby generating a map image corresponding to the address in a customized map field;
customizing and formatting the map image;
creating an advertising message, visual sign, etc., to call out the relevancy of the customized map to the actual DM message; and
printing the DM creative on the DM substrate for mail distribution.

10. The method of claim 9, wherein the customized map field includes a targeted neighborhood bound map.

11. The method of claim 9, wherein the customized map field includes a satellite view map.

12. The method of claim 9, wherein the customized map field includes a street view map.

13. The method of claim 9, wherein the customized map field includes a formatted or enhanced generated map specific to regional recipient preferences.

14. The method of claim 9, wherein the substrate is prepared for postcard or envelope form mailing.

15. The method of claim 9, wherein the customized map field includes a collage of neighborhood street view images.

16. The method of claim 15, wherein the collage includes a highlighted image of street view of the actual house or location of the specific target address, the highlighted image being larger in size than the rest of the images in the collage.

17. A system for manufacturing a physical direct mailing (DM) creative, the system comprising:
a printer;
a processor; and
memory, the memory storing instructions to execute a method, the method comprising:
preparing a main advertising body for printing on a DM substrate;
automatically generating the address of the specific recipient using an automated list or an automated search engine module;
automatically inputting the generated address into a digital MAP address input field, thereby generating a map image corresponding to the address in a customized map field;
customizing and formatting the map image;
creating an advertising message, visual sign, etc., to call out the relevancy of the customized map to the actual DM message; and
printing the DM creative on the DM substrate for mail distribution.

18. The system of claim 17, wherein the customized map field includes a targeted neighborhood bound map.

19. The system of claim 17, wherein the customized map field includes a satellite view map.

20. The system of claim 17, wherein the customized map field includes a street view map.
